(19) United States
(12) Patent Application Publication
(10) Pub. No.: US 2023/0229584 A1
(43) Pub. Date: Jul. 20, 2023

(54) SYSTEM AND METHOD OF WRITING, PLANNING AND EXECUTING MANUAL TESTS UTILIZING HOSTING SERVICES FOR VERSION CONTROL AND A TEMPLATE PROCESSOR

(71) Applicant: S2 Technologies, Inc., Encinitas, CA (US)

(72) Inventors: Mark Underseth, Carlsbad, CA (US); Ivailo Petrov, San Diego, CA (US)

(21) Appl. No.: 17/566,895

(22) Filed: Dec. 31, 2021

(51) Int. Cl. G06F 11/36

(52) U.S. Cl. CPC G06F 11/368; G06F 11/3684; G06F 11/3688; G06F 11/3692

(57) ABSTRACT

A test manager is connected to a hosted version control system containing text files stored in a repository. The test manager receives notification by the version control hosted service of one or more files containing formatted plain text. The formatted plain text includes template language constructs that are pre-processed by the test manager, along with optional defined data, to render manual tests instructions for guiding a human tester to perform operations and observe behavior for a system under test. The user interface is also configured to receive status information from the human tester to be associated with the rendered manual test instructions.

### BACKGROUND

It should be noted that this Background is not intended to be an aid in determining the scope of the claimed subject matter nor be viewed as limiting the claimed subject matter to implementations that solve any or all of the disadvantages or problems presented above. The discussion of any technology, documents, or references in this Background section should not be interpreted as an admission that the material described is prior art to any of the subject matter claimed herein.

Software teams use a variety of tools during development and a large percentage of teams rely on tools that are provided, both commercial and internally implemented, such as version control and template processors.

Exemplary commercially available version control hosting services include GitHub, GitLab, and Bitbucket. These examples are based on the open-source Git distributed version control tool. Git is a version control system used for managing source code, documents, and other artifacts providing a complete history and full version tracking abilities. Software development teams use version control hosting services to store their source code, along with changing history and variations of the source code called branches, in repositories.

Template processors (also known as a template engine or template parser) are included in web publishing systems, application frameworks, and text editors; each supporting specific template language syntax. Exemplary commercially available web publishing systems are Jekyll, and Shopify themes. Examples of scripting languages are Ruby and JavaScript. And examples of text editors are TextMax, Emacs, and Atom. Template processors support features similar to high-level programming languages (variables, loops, etc.), enabling plain text files to contain more sophisticated document formatting generation.

Software teams leverage hosted version control services to store and maintain source code. Teams also use template processors for formatting and generating output, including documents, website pages, and application code.

### SUMMARY

It is understood that various configurations of the subject technology will become apparent to those skilled in the art from the disclosure, wherein various configurations of the subject technology are shown and described by way of illustration. As will be realized, the subject technology is capable of other and different configurations and its several details are capable of modification in various other respects, all without departing from the scope of the subject technology. Accordingly, the summary, drawings, and detailed description are to be regarded as illustrative in nature and not as restrictive.

One aspect comprises a system for implementing and executing manual tests using text files, containing formatted plain text and template language constructs, maintained and controlled using a version control hosting service. The text files are pre-processed to render manual test instructions used for guiding the human tester. The system comprises a processor; and a test manager, executing on the processor. The test manager is connected to a version control hosting service and configured to be notified in response to the creation of a test project and identify one or more text files, containing formatted plain text and template language constructs, that are stored and maintained by a version control hosting service. The test manager is also configured to display a user interface having information indicating the manual tests to be executed and providing rendered test instructions for the human tester. The user interface is also configured to receive status information from the human tester associated with the rendered manual test instructions.

Another aspect comprises a method for implementing and executing manual tests using text files, containing formatted plain text and template language constructs, maintained and controlled using a version control hosting service. The text files are pre-processed to render manual test instructions used for guiding the human tester. The method comprises receiving notification in response to the creation of a test project and configured to identify one or more text files, containing formatted plain text and template language constructs, that are stored and maintained by a version control hosting service. The method comprises displaying a user interface having information indicating the manual tests to be executed and providing rendered test instructions for the human tester. The method receives status information from the user interface to be associated with the rendered manual test instructions.

Yet another aspect comprises a program storage device storing instructions that when executed perform the method comprising receiving notification in response to the creation of a test project and configured to identify one or more text files, containing formatted plain text and template language constructs, that are stored and maintained by a version control hosting service. The test instructions are to be pre-processed for generating manual tests. The program storage device also includes a user interface having information indicating the manual tests to be executed and providing rendered test instructions for the human tester. The program storage device also includes receiving status information via the user interface from the human testers.

### BRIEF DESCRIPTION OF THE DRAWINGS

Various embodiments are discussed in detail in conjunction with the Figures described below, with an emphasis on highlighting the advantageous features. These embodiments are for illustrative purposes only and any scale that may be illustrated therein does not limit the scope of the technology disclosed.

FIG. 1 is a block diagram illustrating a system for retrieving text files from a version control hosting service and presenting pre-processed files as guiding manual test instructions to a human tester.

FIG. 2 is a block diagram representing one or more users of the version control hosting service of FIG. 1 committing formatted plain text files containing template language constructs into a repository.

FIG. 3 is a flowchart illustrating an implementation process of retrieving text files from a version control hosting service of FIG. 1 and pre-processing the files and rendering them as manual test instructions for a human tester.

FIG. 3A is an exemplary screen display of the test manager of FIG. 1 of the input and status of testing that is performed using the test manager of FIG. 1.

FIG. 4 is a flowchart illustrating the steps of pre-processing text files containing template language constructs that also include associated data using the test manager and a version control hosting service of FIG. 1.

FIG. 4A is an exemplary screen display of a user interface allowing template construct data to be entered via a user using the test manager of FIG. 1.

FIG. 5 is an exemplary formatted plain text file containing template language constructs the test manager of FIG. 1 retrieves from a version control hosted service and pre-processes.

FIG. 5A is an exemplary screen display of rendering manual test instructions for a human tester using the plain text file in FIG. 5 using the test manager of FIG. 1.

### DETAILED DESCRIPTION

It is understood that various configurations of the subject technology will become apparent to those skilled in the art from the disclosure, wherein various configurations The following description and examples illustrate some exemplary implementations, embodiments, and arrangements of the disclosed invention in detail. Those of skill in the art will recognize that there are numerous variations and modifications of this invention that are encompassed by its scope. Accordingly, the description of a certain exemplary embodiment should not be deemed to limit the scope of the present invention.

Various aspects of the novel systems, apparatuses, and methods are described more fully hereinafter with reference to the accompanying drawings. The teachings disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein one skilled in the art should appreciate that the scope of the disclosure is intended to cover any aspect of the novel systems, apparatuses, and methods disclosed herein, whether implemented independently of or combined with any other aspect of the disclosure. For example, a system or an apparatus may be implemented, or a method may be practiced using any one or more of the aspects set forth herein. In addition, the scope of the disclosure is intended to cover such a system, apparatus, or method which is practiced using other structure, functionality, or structure and functionality in addition to or other than the various aspects of the disclosure set forth herein. It should be understood that any aspect disclosed herein may be set forth in one or more elements of a claim. Although some benefits and advantages of the preferred aspects are mentioned, the scope of the disclosure is not intended to be limited to particular benefits, uses, or objectives. The detailed description and drawings are merely illustrative of the disclosure rather than limiting, the scope of the disclosure being defined by the appended claims and equivalents thereof.

With respect to the use of plural vs. singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that terms used herein, and especially in the appended claims (e.g., bodies of the appended claims) are intended as “open” terms unless specifically indicated otherwise (e.g., the term “including” should be interpreted as “including but not limited to,” the term “having” should be interpreted as “having at least,” the term “includes” should be interpreted as “includes but is not limited to,” etc.).

It will be further understood by those within the art that if a specific number of an introduced claim recitation is intended, such an intent will be explicitly recited in the claim, and in the absence of such recitation, no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations or two or more recitations).

In those instances where a convention analogous to “at least one of A, B, and C” is used, such construction would include systems that have A alone, B alone, C alone, A and B together without C, A and C together without B, B and C together without A, as well as A, B, and C together. It will be further understood by those within the art that virtually any disjunctive word and/or phrase presenting two or more alternative terms, whether in the description, claims, or drawings, should be understood to contemplate the possibilities of including one of the terms, either of the terms or both terms. For example, the phrase “A or B″ will be understood to include A without B, B without A, as well as A and B together.” Various modifications to the implementations described in this disclosure can be readily apparent to those skilled in the art, and the generic principles defined herein can be applied to other implementations without departing from the spirit or scope of this disclosure. Thus, the disclosure is not intended to be limited to the implementations shown herein but is to be accorded the widest scope consistent with the claims, the principles, and the novel features disclosed herein. The word “exemplary” is used exclusively herein to mean “serving as an example, instance, or illustration.” Any implementation described herein as “exemplary” is not necessarily to be construed as preferred or advantageous over other implementations. Certain features that are described in this specification in the context of separate implementations also can be implemented in combination in a single implementation. Conversely, various features that are described in the context of a single implementation also can be implemented in multiple implementations separately or in any suitable sub-combination. Moreover, although features can be described above as acting in certain combinations and even initially claimed as such, one or more features from a claimed combination can in some cases be excised from the combination, and the claimed combination can be directed to a sub-combination or variation of a sub-combination.

The methods disclosed herein comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

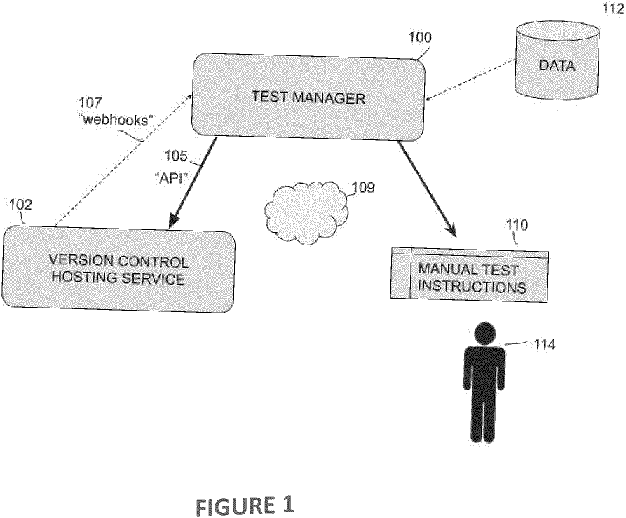

FIG. 1 is a block diagram illustrating a test manager 100 connected to a version control hosting service 102. The version control hosting service 102 can be used to store text files. The test manager 100 is software that retrieves text files stored in a version control hosting service 102, includes data 112 associated with the text files, and renders the contents of the files as manual test instructions 110 to guide a human tester 114 to run at least one manual for the system under test. The stored text files include formatted plain text and template language constructs that are pre-processed by the test manager 100 to render the manual test instructions 110.

The test manager 100, in one embodiment, communicates with the version control hosting service 102 interfaces 105, 107 via a network 109. Version control hosting services 102 can be based on the open-source Git distributed version control system, which is used, among many other features, for tracking changes in source code during software development. Examples of version control hosting services based on Git that are commercially available products, such as but not limited to are GitHub, Bitbucket, and GitLab. The network 109 can include the Internet, a local area network, or a wide area network, or a virtual network being emulated on a point-to-point system.

The test manager 100 may be configured to run on a processor of a computing device, such as a desktop application, or as a server application on the Internet that is accessed by a tester via a web browser. The processor may be any conventional general-purpose single- or multi-chip microprocessors such as but not limited to an x86, x86-64, ARM64, an 8051 processor, a MIPS® processor, a Power PC® processor, or an Alpha® processor. In addition, the microprocessor may be any conventional special purpose microprocessor such as a digital signal processor or a graphics processor. The microprocessor typically has conventional address lines, conventional data lines, and one or more conventional control lines. A human tester accesses one or more user interfaces of the test manager 100 via network 109 and a network browser of an electronic device connected to network 109.

The version control hosting service 102 export application programming interfaces (“API”) 105 allow 3rd parties to communicate and provide additional functionality to users of the hosting service. An exemplary API is described in the GitHub Developer Guide, https://developer.github.com/v3/, as of December 2021, which is hereby incorporated by reference in its entirety. As used herein, the API, e.g., GET, PUT, PATCH, POST, and DELETE commands may be used to extract and post information to and from the respective service. The API may also include a callback technique commonly called webhooks 107 as a mechanism by which information is provided to the test manager 100. The test manager 100, acting as a client, uses the API, to access a user’s set of repositories and/or an organization’s set of repositories in the version control hosting service 102. A repository is defined as a container of content such as source code. History tracking and revision control are built into the version control hosting service 102.

Thus, there are generally two groups of individuals accessing the version control hosting service, human testers who access certain information from the version control hosting service 102 via the test manager 100 and software developers and/or managers who interface directly with an interface of a web portal of the version control hosting service 102. A software developer and/or manager of the version control hosting service 102 may access the service via network 109 and use a network browser of an electronic device of the developer. Unless proscribed by an organization, a direct user of the version control hosting service is not precluded from accessing the version control hosting service information 102 via the test manager 100 and vice versa. As used herein, a “user of the version control hosting service” refers to an individual who accesses the version control hosting service information 102 directly via a web portal of the version control hosting service 102.

The hosting services 102 and the test manager 100 can be provided by a single commercial product or by multiple commercial products. For example, in one embodiment, the version control hosting service 102 and the test manager 100 configured as a separate application communicates with the services of each of them via an API provided by the single integrated application. In another embodiment, the version control hosting service 102, and the test manager 100 are integrated into a single application and the respective services are invoked by the services of the other via an internal API or otherwise directly invoked via a private link, API, port, or communication channel.

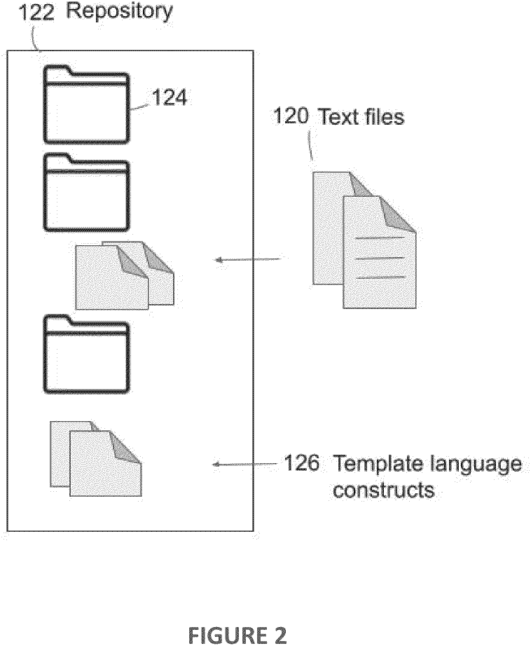

FIG. 2 is a block diagram representing one or more users of a version control hosting service 102 committing text files 120 into a repository 122. Text files 120 contain formatted plain text describing how to test the software manually. The text files 120 are handled the same as files containing textual-based programming language instructions (e.g. source code) when being stored and maintained in a repository 122. The text files 120 can be organized and version-controlled within folders/sub-folders 124 and separate branches of the repository 122. A branch is a controlled variation of an existing baseline within a repository. In one embodiment, the formatted plain text uses a lightweight markup language such as, but not limited to, markdown or textile, defining the steps to be performed on the system under test by a human tester 114. The formatted plain text can reference external links and images. Images can be stored in the repository 122 or elsewhere. In another embodiment, the formatted plain text uses a business-driven development language format, but not limited to, such as Gherkin. The formatted plain text can include template language constructs 126. In one embodiment the template language constructs can be represented by a specific syntax description within the text file 120, by an external file 126, and/or within the user interface. Template language constructs 126 follow prescribed syntax as defined by, but not limited to, web publishing systems, application frameworks, text editors, and proprietary in-house tools.

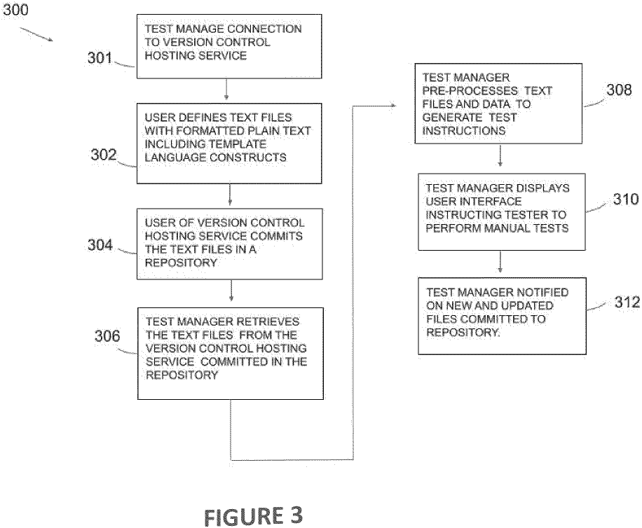

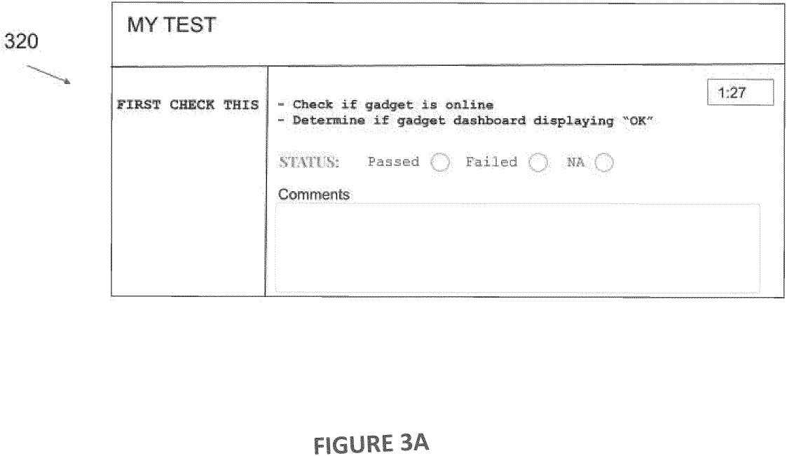

FIG. 3 is a flowchart illustrating an end-to-end process of version control hosting service 102 connection, text file storage, and text file pre-processing for rendering manual test instructions 110 for a human tester 114. The test manager 100 is connected to a version control hosting service 102, enabling the automatic discovery of text files maintained and updated by the user. The text files include template language constructs 126, with referenced data 112, used in the rendering of manual test instructions 110 for the human tester 114. Additional steps may be added, others removed, and the ordering of the steps rearranged.

Starting at step 301 the test manager 100 is connected via an application integration with the version control hosting service 102. An example, but not limited to, is a connection to GitHub. How to connect to GitHub can be found in, https://docs.github.com/en/developers/apps/building-github-apps/creating-a-githu b-app, as of December 2021, which is hereby incorporated by reference in its entirety. As part of the integration with the version control hosting service 102 an export application programming interface (“API”) 105 allows integrated applications to communicate and provide additional functionality to users of the version control hosting service 102.

Continuing at step 302 a user defines text files consisting of formatted plain text, including template language constructs, to be committed to the version control hosting service 102.

Set forth below is a certain exemplary text file that contains markdown formatted plain text, including template language constructs. The template language constructs used in this example are based on Shopify’s Liquid template language used for web apps, as described here: https://shopify.github.io/liquid/.

# MY TEST
This test covers some very important stuff.
{% include setup.md %}
## FIRST CHECK THIS
Verifies that stuff comes up as expected
{% if product == 1 %}
- Check if gadget is online
- Determine if gadget dashboard displaying “OK”
{% else %}
- Check if super-gadget is online
- Determine if super-gadget is dashboard display “YES”
{% endif %}

The character “#” indicates the start of a test definition followed by the name of the test. The character set “##” indicates a specific case to be verified. The statements between characters “{%” and “%}” specify Liquid template statements, called tags, are used to create logic and control flow. In this example, there is an “include” tag that is used to include another text file also containing formatted plain text and optionally template language constructs. The Liquid tag “if-else-endif” is conditional logic, based on the value of the template variable “product”. The characters and keywords used for template constructs are examples only and other text-based indicators and/or commercially available template languages may be used. Also, additional steps and template language constructs may be added, others removed, and the ordering rearranged. The number of tests and/or cases, represented by “#” and “##”, may be added, removed, or rearranged.

Continuing at step 304, a user of the version control hosting service commits text files 120, in a repository 122. The text files 120 contain formatted plain text, such as the markup language defined by markdown, but not limited to, and includes template language constructs 126 such as those defined by the Shopify’ Liquid template language, but not limited to. The formatted plain text and template language constructs can reference external links and images. Images can be stored in the repository 122 or elsewhere.

Next, at step 306, the test manager 100, in one embodiment, utilizing the API of the version control hosting service 102, extracts a copy of the files 120 maintained in repository 122. In one embodiment, the files 120 are then stored locally on a computer hosting the test manager 100.

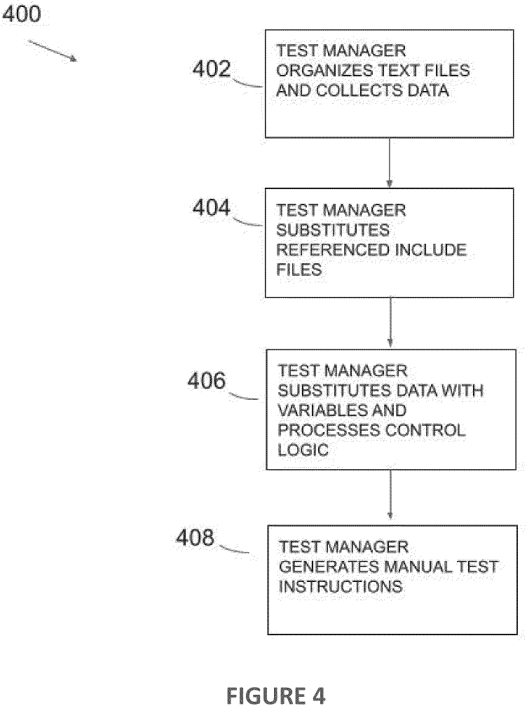

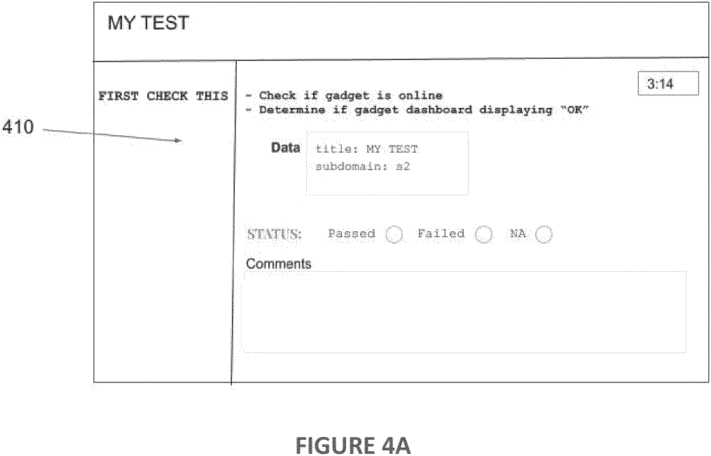

Next, at step 308, the test manager 100, pre-processes the text files containing formatted plain text and template language constructs, retrieved from the version control hosting service 102. An exemplary process of the test manager 100 pre-processing the text files, along with any data, and generating test instructions to be used for rendering is described below with respect to FIG. 4.

Next, at step 310, the test manager 100 displays a user interface 320 (FIG. 3A) that includes the rendered manual test instructions, used to guide the human tester 114 to perform operations and observe behavior on the system under test. The user interface can include: a window displaying the name of the tests, a graphical control to trigger the execution and timing of the test, a form allowing the tester to specify whether the test passed or failed, and any notes the tester may have regarding the execution of the test. The user interface 320 can also be adapted to show a name of a tester that had been assigned by a user to perform the test.

Continuing to step 312, the version control hosting service 102 notifies the test manager 100 of the existence of changes to the text files 120 within the repository 122. Test files can be added, removed, or modified. In one embodiment, the test manager 100 previously registered, via an application programming interface (“API”), with the version control hosting service 102 to receive a notification via a webhook 107 when a new commit of changes occurs within the repository.

FIG. 4 is a flowchart illustrating the test manager 100 processes of assembling text files 120, collecting data 112 that is defined and/or dynamically generated, substituting file inclusions, and determining control logic 126 for the generation of the manual test instructions. Additional steps may be added, others removed, and the ordering of the steps rearranged.

Starting at step 402 the test manager 100 organizes all of the text files for pre-processing and collects defined data 112. Data is used along with the template language constructs 126 in transforming the text files. One approach, but not limited to, is defining data values within the text file by containing a YAML front matter block. Set forth below is a certain exemplary text file that contains name/value pairs within a front matter format separated between triple-dashed lines:

title: MY TEST
subdomain: s2

FIG. 4A is an exemplary screen display 410 of the test manager 100 presents a user interface allowing data 112 to be entered and optionally persisted. The user-entered data is collected during and/or before a testing session.

In one embodiment, data 112 can be dynamically generated. In some applications, this type of dynamic data is called “context” and is based on the execution environment. The dynamic data (names/values) can be resolved during the creation and/or during the test execution runtime by the test manager 100. Examples of dynamic data (context), but not limited to, are user names, current date, test session name, project name, repository name, etc. Set forth below is a certain exemplary text file that makes use of dynamic data in the generation of test instructions.

## Case 1
- Do this using {{ project.name }}
- Do that

The character sequence {{ project.name }} references a defined dynamic data value that is supported by the test manager 100 and provides the name of the assigned test project to be used in the test instructions. There are no limits to the number of dynamic data values supported by the test manager. The characters and keywords used for referencing dynamic data are examples only and other techniques may be used.

Continuing at step 404, the test manager 100 substitutes referenced include files into the body of the file making the reference. Set forth below is a certain exemplary text file that uses an “include” tag to include another text file also containing formatted plain text and optionally template language constructs.

## Case 1
- Do this
- Do that
{% include moreInstructions.md %}

The character sequence { % include moreInstructions.md %} references an existing formatted plain text file that is inserted and is used as part of the test instructions. There are no limits to the number of included files supported by the test manager. The characters and keywords used for referencing included files are examples only and other techniques may be used.

Continuing at step 406, the test manager 100 substitutes referenced objects and variables with collected data, processes control logic along with variable assignments. Set forth below is a certain exemplary text file that uses a “conditional logic” tag and “variables” processed by the test manager 100 used in the generation of test instructions.

{% if spec.OS == ‘Windows’ %}
- check for Windows stuff.
{% elsif spec.OS == ‘Linux’ %}
- check for Linux stuff
{% else %}
- check for Mac stuff
{% endif %)}

The character sequence {% if spec.OS == TEXT%} references variables and generates test instructions based on the condition being met. There are no limits to the number of variables and control logic supported by the test manager. The characters and keywords used for referencing variables and using control logic are examples only and other techniques may be used.

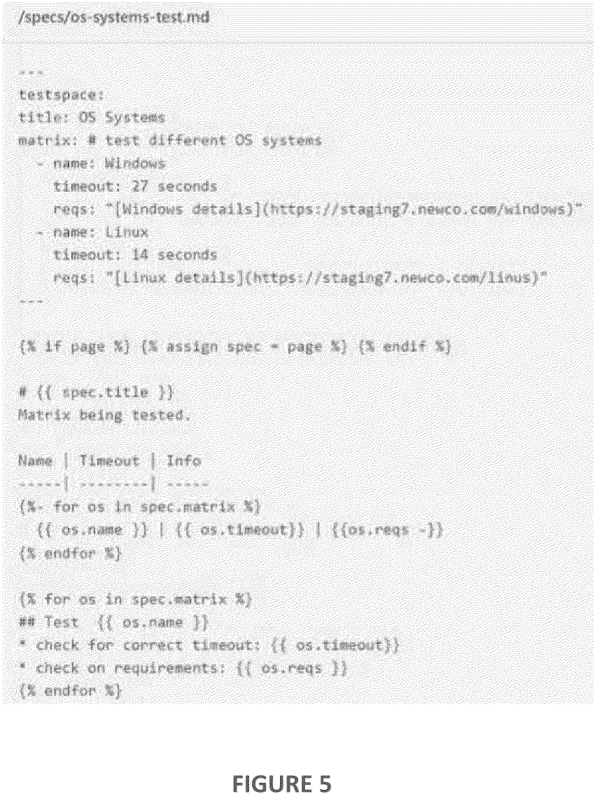

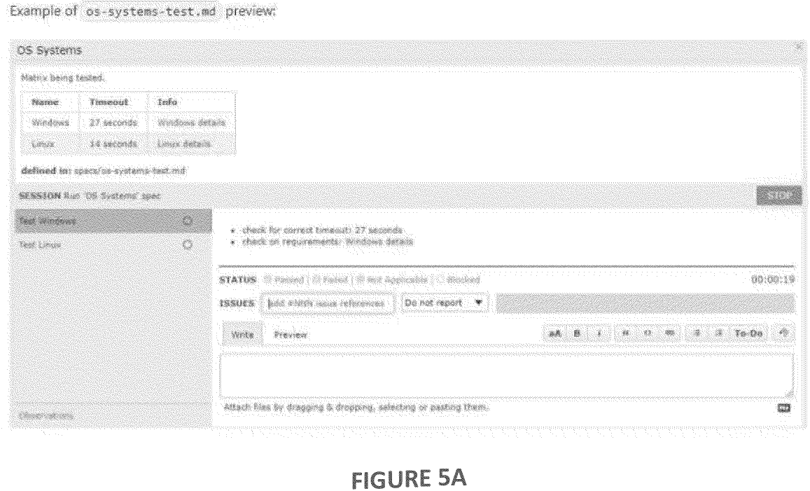

Continuing at step 408, the test manager 100 renders the content into manual test instructions 110. FIG. 5 is an exemplary text file 120, containing formatted plain text and template language constructs 126, that is pre-processed and formatted into guiding manual test instructions 110 (FIG. 5A) to be executed by a human tester 114.

What is claimed is:

1. A system for implementing and executing manual tests for a system under test, comprising:
a processor; and
a test manager, executing on the processor, the test manager configured to be connected to a version control hosting service and notified in response to the creation of a test project and setup to identify one or more files containing formatted plain text stored and maintained by a version control hosting service, the formatted plain text containing template language constructs, the test manager also configured to pre-process the formatted plain text, including the template language constructs, used to render manual test instructions to be executed by a human tester,
the test manager is configured to display a user interface having information indicating the manual tests to be executed and providing guiding instructions for the execution of the tests, the user interface is also configured to receive status information from the human tester, and display status information of the execution associated with the rendered manual test instructions.

2. The system of claim 1, wherein the test manager receives data to pre-process with the template language constructs contained in the files, used to render the formatted plain text as manual test instructions to be executed by the human tester on the system under test, the received data being from the text files stored and maintained by a version control hosting service and/or other persisted storage.

3. The system of claim 2, the test manager configured to display a user interface to receive values from a user as input for the data used to pre-process with the template language constructs contained in the files, used to render the formatted plain text as manual test instructions to be executed by the human tester.

4. The system of claim 2, wherein the test manager is further configured to resolve defined and/or dynamic data values during the runtime execution of the manual test used to pre-process with the template language constructs contained in the files, used to render the formatted plain text as manual test instructions to be executed by the human tester.

5. The system of claim 1, wherein the test manager communicates with the version control hosted service via an external application programming interface that is exported by each of the respective services.

6. The system of claim 1, wherein services of the test manager, and the version control hosting service are integrated together within a single application.

7. A method for executing tests for a system under test, comprising:
receiving notification in response to the creation of a test project;
identifying one or more files containing plain text instructions that are stored and maintained by a version control hosting service, the formatted plain text containing template language constructs, the text file to be pre-processed used to render manual test instructions to be executed by a human tester on the system under test;
displaying a user interface having information indicating the manual test to be executed and providing guiding instructions for the execution of the tests; and
receiving status information from the human tester.

8. The method of claim 7, wherein received data to be pre-processed along with the template language constructs contained in files used to render the formatted plain text as manual test instructions to be executed by the human tester.

9. The method of claim 8, wherein received user input identified as values for the data to be pre-processed along with the template language constructs contained in files used to render the formatted plain text as manual test instructions to be executed by the human tester.

10. The method of claim 8, wherein the data is dynamically resolved during runtime to be pre-processed along with the template language constructs contained in files used to render the formatted plain text as manual test instructions to be executed by the human tester.

11. The method of claim 7, wherein the text instructions are received via an external application programming interface that is exported by the version control hosting service.

12. A program storage device storing instructions that when executed performs the method comprising:
receiving notification in response to the creation of a test project;
identifying one or more files containing plain text instructions that are stored and maintained by a version control hosting service, the formatted plain text containing template language constructs, the text file to be pre-processed used to render manual test instructions to be executed by a human tester on the system under test;
displaying a user interface having information indicating the manual test to be executed and providing guiding instructions for the execution of the tests; and
receiving status information from the human tester.

13. The program storage device of claim 12, further comprising instructions to receive data used along with the template language constructs contained in files used to render the formatted plain text as manual test instructions to be executed by the human tester.

14. The program storage device of claim 13, received user input identified as values for the data used along with the template language constructs contained in files used to render the formatted plain text as manual test instructions to be executed by the human tester.

15. The program storage device of claim 13, wherein the data is dynamically resolved during runtime to be pre-processed along with the template language constructs contained in files used to render the formatted plain text as manual test instructions to be executed by the human tester.

16. The program storage device of claim 12, further comprising instructions for communicating with the version control hosting service via an external application programming interface.
